(19) United States
(12) Patent Application Publication
(10) Pub. No.: US 2010/0276458 A1
(43) Pub. Date: Nov. 4, 2010

(54) Device for dispensing material for processing and use of said device

(75) Inventor: Manuel Buck, Vogelsangstrasse (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/308,255

(22) PCT Filed: Jun. 28, 2007
(86) PCT No.: PCT/EP2007/056496

§ 371 Date: Dec. 11, 2008

(30) Foreign Application Priority Data
Jun. 28, 2006 (EP) 06116239.2

(51) Int. Cl. B67D 7/64

(52) U.S. Cl. 222/327; 222/1; 222/319

(57) ABSTRACT

The device (1000), for dispensing viscous or pasty material (42), such as sealing materials or adhesives, comprises a drive unit (2) in a housing (3), by means of which a main guide rod (1) which may be connected at the front end thereof to a piston (5, 500) is mounted such as to be axially movable, introducible into a main cylinder (9) and connectable to the drive unit (2) on the drive side by first assembly means (8′, 23) and retains at least one sealing element (7, 71; 700; 701) on the front side thereof by means of two assembly means (8; 800). The piston (5; 500) driven by the main guide rod (1) acts on the material (42) and forces the same out of the main cylinder (9) through the sealing element (7, 71; 700; 701). According to the invention, an auxiliary cylinder (900) held coaxially in the main cylinder (9) and filled with the material (42) for dispensing, is provided, which has the sealing element (700; 701) retained by the second assembly means (8; 800) on the front thereof and the piston (500) is arranged therein on the drive side, which may be driven by the main guide rod (1).

### TECHNICAL FIELD

The invention is based on a device for dispensing viscous or pasty material, such as sealing material or adhesive, according to the preamble of the first claim.

### PRIOR ART

Devices of the type in question, which are referred to in the art as injection guns, caulk guns or sealant guns and which are known for example from [1], WO 2005/120720 A1, serve for dispensing a metered quantity of the materials to be processed and for this purpose typically have a manually, electrically or pneumatically actuated drive. Electrically driven devices are manufactured, for example, by MILWAUKEE ELECTRIC TOOL CORPORATION (see http://www.milwaukeetool.com, model series 6560-2×).

The device disclosed in [1] allows sealing material to be dispensed from a bag which can be introduced into a cylinder of the device, which cylinder is a constituent part of the device and can therefore be loaded with bags as often as desired. It is also possible to operate with cartridges, in which case a cartridge holder is required (see [1], FIG. 10).

The use of bags containing sealing material, instead of single-use cartridges, has the major advantage that on the one hand they can be acquired more cost-effectively and on the other hand produce only a small amount of waste after use. For operation with 600 ml film bags, for example, a cylinder provided with closure elements, hereinafter referred to as a main cylinder, is required.

The device known from [1] and shown below in FIGS. 1, 2 and 7b comprises a drive unit 2 by means of which a main guide rod 1 connected on its front side to a main piston 5 is mounted in an axially displaceable manner and can be introduced into the main cylinder 9 in such a way that the main piston 5 acts on the material 42 provided in the main cylinder 9 and can displace this material through a closure piece 7 and an outlet nozzle 71 and out of the main cylinder 9.

It is possible by means of devices of this type, which operate at a conveying force of 2500 N to 3000 N and a resulting pressure of 2-3 bar, for large quantities of material to be dispensed quickly and in a controlled manner in order, for example, to close joints or gaps with sealing material or to apply adhesive to elements which are to be connected.

It is particularly in the building trade that the device described in [1], which is often operated by means of rechargeable accumulator batteries, is extraordinarily practical since, for example, joints on floors, walls and ceilings are readily accessible and can therefore be treated quickly.

Adhesives and sealants are also used in various other areas of industry. In the automotive industry, for example, the rear window and the front window can be provided with a bead of adhesive in the edge region using the device and set down on a peripheral flange of a vehicle opening, as is described in [2], DE1 630 371 A1, for thermoplastic materials which are additionally heated for curing purposes.

For the production of buildings and products, the device known from [1] is therefore satisfactory in a wide range of applications. This is particularly also because the objects are normally designed to be treated or processed with the required tools, including the above-described devices, or are produced in tailored operating sequences.

By contrast, particularly when defects occur on finished products or objects, conditions often prevail in which the areas to be treated or processed are not accessible for the above-described devices. To avoid now having to disassemble the products or buildings, use could be made of special devices which allow the sealing or adhesive materials to be conveyed for example over relatively large distances to the corresponding areas through lines having small inside and outside diameters. However, when using lines having a small inside diameter, higher pressures which cannot be generated by the devices described are required.

Where special devices are used, these preferably have to be supplied with the same material and have to be maintained. If, for example, the damaged front window of a vehicle has to be replaced, the adhesive can be conveniently applied to the new window using the device known from [1]. The adhesive can also be applied directly to the flange on which the new window is placed. However, this is more complicated and is avoided in practice.

If after completing the repair an unsealed area is now discovered and located, the faulty area is no longer accessible for devices of the type described, which means that the said special devices are required or the mounted window has to be removed again. The repair work is therefore considerably more involved and more expensive. Although the special devices are only rarely used, they have to be kept on standby and, even when only employed for a single use, have to be filled with adhesive and then cleaned.

In other applications, too, it would often be desirable if, without additional costs, material for another device could be dispensed at a considerably higher pressure than is possible using the device described in [1].

### SUMMARY OF THE INVENTION

The object on which the invention is based is to provide an improved device of the type mentioned in the introduction by means of which viscous or pasty material, such as sealing material and adhesive, can be dispensed at a desired pressure.

It is particularly intended to provide a cost-effective device of simple design by means of which material can be dispensed under a pressure which is higher by a multiple than the maximum pressure which can be generated by the devices described in the introduction.

Where a device of the generic type is already available, the need for a second device should preferably be avoided.

According to the invention, this is achieved by the features of the first claim. Further advantageous embodiments of the invention are given in the subclaims.

The device, which serves for dispensing viscous or pasty material, such as sealing material or adhesive, comprises a drive unit which is provided in a housing and by means of which a main guide rod which can be connected on its front side to a piston is mounted in an axially displaceable manner and can be introduced into a main cylinder, which is connected on the drive side to the drive unit by first mounting means and which on the front side holds at least one closure element by way of second mounting means, in such a way that the piston driven by the main guide rod can act on the material and displace this material through the closure and outlet element and out of the main cylinder. According to the invention, there is provided an auxiliary cylinder which is filled with the material to be dispensed and which is held coaxially in the main cylinder, this auxiliary cylinder being provided on the front side with the closure element held by the second mounting means and having arranged therein, on the drive side, the piston (auxiliary piston hereinafter) which can be driven by means of the main guide rod.

The inside diameter of the hollow cylindrical auxiliary cylinder in relation to the inside diameter of the hollow cylindrical main cylinder or in relation to the force supplied by the drive unit via the main guide rod is selected such that the material can be pressed out of the auxiliary cylinder at a desired pressure. The ratio of the inside diameters here is preferably in the range from 0.1 to 0.75.

With a ratio of the inside diameters of 0.1, there results in the auxiliary cylinder a pressure which is higher by a factor of 100 than the pressure which, without the use of the auxiliary cylinder, results only in the main cylinder. With a ratio of the inside diameters of 0.75, by contrast, the pressure is almost doubled. In applications in which adhesive is dispensed via a thin plastic hose having an inside diameter of 2 mm-6 mm, a pressure of 100-150 bar is preferably provided. By correspondingly dimensioning and using one or more auxiliary cylinders which can be used as alternatives, the pressure range can therefore be selected as desired. Where the force generated by the drive unit is controllable, the pressure within each pressure range can additionally be infinitely regulated. When using smaller auxiliary cylinders, care should preferably be taken to ensure that sufficient material for the intended application is contained therein.

By means of the solution according to the invention, it is thus possible by installing the auxiliary cylinder for a conventional device, as is described for example in [1], to be converted into a device which is suitable for dispensing materials at a pressure which can be selected virtually as desired. Consequently, the same material which is dispensed at a low pressure from the device without an auxiliary cylinder can be dispensed at a high pressure from the same device, yet with this device supplemented by the auxiliary cylinder, and fed for example via a thin hose and over relatively large distances to areas which are otherwise not accessible. As a result, gaps in a sealing material or cavities can reliably be filled with the same material. It is therefore not necessary to switch to materials which have a lower viscosity or to use special devices by means of which higher pressures can be generated. Because the same device and the same material is used for virtually all applications, this results on the one hand in minimum effort and minimum costs and on the other hand in a high quality of work which can be carried out quickly and precisely, while completely avoiding possible problems with incompatibilities between materials which could arise when more than one material is used.

The auxiliary cylinders are preferably produced from cost-effective service pipes as are used by electricians. The filling of one or more auxiliary pipes can be carried out at relatively low pressure with the device in the configuration shown in FIG. 1. For this purpose, the auxiliary piston is preferably introduced into the front side of the auxiliary cylinder and displaced by the poured-in material towards the other end of the auxiliary cylinder. After sufficient material has been poured into the auxiliary cylinder, the latter is closed off at its front side with a closure element. A closure element, provided with a through bore, with a polygonal profile and with a thread, is preferably screwed into an internal thread provided on the front side of the auxiliary cylinder. It is advantageous to use a closure piece with a through bore into which can be inserted a plastic hose (for example of nylon, polyurethane or FEP 140 fluoro-polymer) which is automatically held and sealed and can be released again by actuating a locking element. Fittings of this type can be obtained for example from LEGRIS SA, BP 70411, F-35704 Rennes (http://www.legris.com/) (see for example the LF3600 system). It is possible to use any other closure elements which are provided for example with outlet nozzles.

The mounting ring connected on the front side to the main cylinder is preferably used to hold a retaining disc with an opening through which the hose provided on the closure element is routed outwardly and whose edge region simultaneously forms a flange by which the auxiliary cylinder is secured. The retaining disc, which is preferably made of metal, ensures that the force acting from the auxiliary cylinder is transmitted to the outer edge of the mounting ring, with the result that it is not loaded more than during the operation of the device in the lower pressure range.

The main guide rod can act directly on the auxiliary piston provided in the auxiliary cylinder. However, it is also possible to use an auxiliary guide rod which is connected to a main piston which, during operation of the device in the low pressure range, is fitted onto the main guide rod and displaces the material out of the main cylinder. The use of the auxiliary guide rod makes it possible to avoid disassembling the main piston if the device is intended to be equipped with the auxiliary cylinder.

The auxiliary cylinder can be mounted in the main cylinder in various ways.

It is particularly simple to mount the auxiliary cylinder if it is inserted, preferably clearance-free, into a hollow cylindrical reducing cylinder which in turn can be inserted, preferably clearance-free, into the main cylinder. As a result, the auxiliary cylinder is automatically aligned coaxially to the axis of the main cylinder such that the main guide rod, or, if appropriate, the auxiliary guide rod, strikes the auxiliary piston provided in the auxiliary cylinder with targeted precision.

When using an auxiliary guide rod, the latter is held for example in the bore of the auxiliary cylinder or in the main cylinder by means of at least one centring element. Mounting the auxiliary cylinder therefore first requires the auxiliary guide rod, for example together with the centring element, and then the reducing cylinder provided with the auxiliary cylinder to be inserted into the main cylinder, after which this main cylinder is closed off on the front side with the mounting ring and, if appropriate, the retaining disc. Here, switching between the various configurations of the device involves few manipulations in each case.

After the auxiliary cylinder has been installed, the material can be dispensed immediately. To ensure that the material is completely expelled from the auxiliary cylinder, preference is given to using an auxiliary piston which is made of plastic or metal and which is provided with at least one peripheral collar which bears against the inner wall of the auxiliary cylinder.

The viscous or pasty material particularly preferably takes the form of pasty compositions which contain reactive prepolymers. It is particularly preferable for such prepolymers to contain isocyanate and/or alkoxy-silane groups. Particular preference is given to pasty, preferably thixotroped pasty, adhesives and/or sealants, in particular one-component moisture-curing polyurethane adhesives, as marketed, for example, by Sika Schweiz AG under the Sikaflex® brand, by Dow Automotive under the BETASEAL® and BETAMATE® brands or by Henkel Teroson GmbH under the trade name Terostat.

As has been described above, the device according to the invention is suitable for dispensing material under high pressure and via thin and, if appropriate, flexible lines. The device can therefore be used particularly in the building or automotive sector advantageously to carry out repairs on areas of an object which are not readily accessible. Particularly after mounting a window on an automobile, defective areas, which are preferably located using ultrasound, can be reached and repaired without problem.

### BRIEF DESCRIPTION OF THE DRAWING

Exemplary embodiments of the invention will be explained in more detail below with reference to the drawings. Like elements are provided in the various figures with the same reference signs. Only those elements which are essential for the immediate understanding of the invention have been shown. The flow direction of the media is depicted by arrows.

FIG. 1 shows a longitudinal section through the front part of a device 1000′ known from [1] by means of which material 42 contained in a bag 4 is expelled from a main cylinder 9 by means of a main guide rod 1 and a main piston 5 mounted thereon;

FIG. 2 shows the device of FIG. 1 after the complete emptying of the bag 4;

FIG. 3 shows a longitudinal section through the front part of the device 1000 of FIG. 1 as expanded according to the invention, this front part being equipped with an auxiliary cylinder 900 which is held in a reducing cylinder 90 and is filled with material 42 to be processed, in which auxiliary cylinder is arranged an auxiliary piston 500 which is actuated by means of the main guide rod 1;

FIG. 4 shows the device 1000 of FIG. 3 with an auxiliary guide rod 100 which on the drive side butts against the main piston 5 of the device and on the front side butts against the auxiliary piston 500 provided in the auxiliary cylinder 900;

FIG. 5 shows the auxiliary guide rod 100 held in the main cylinder 9 by means of two centring elements 101, 102;

FIGS. 6a-6e show the preparation and mounting of an auxiliary cylinder 900;

FIG. 7a shows the device 1000′ known from [1];

FIG. 7b shows the device 1000 of FIG. 7a as expanded according to the invention;

FIG. 8 shows a detail of a glass window A and a metal flange B which are connected to one another by means of an adhesive bead 42 which has a gap to be repaired; and

FIG. 9 shows the repair of the gap in FIG. 8 being carried out by means of a device 1000 according to the invention.

### WAY OF IMPLEMENTING THE INVENTION

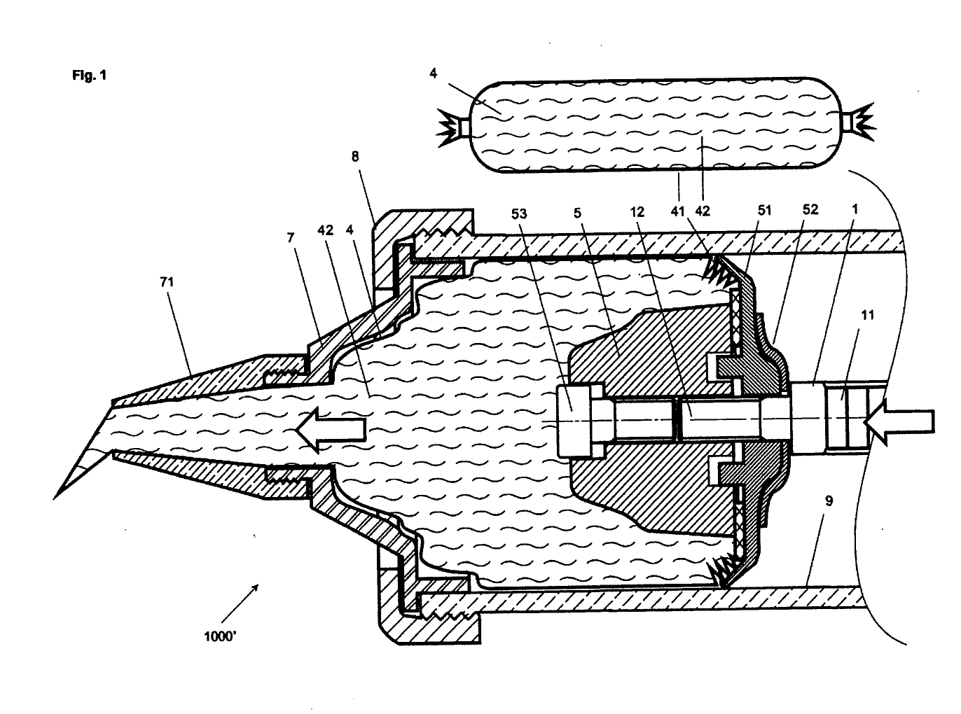

FIGS. 1, 2 and 7b show various representations of the device 1000′ known from [1] which is suitable for dispensing viscous or pasty material, such as sealing material and adhesive, at a relatively low pressure typically ranging from 1-2 bar.

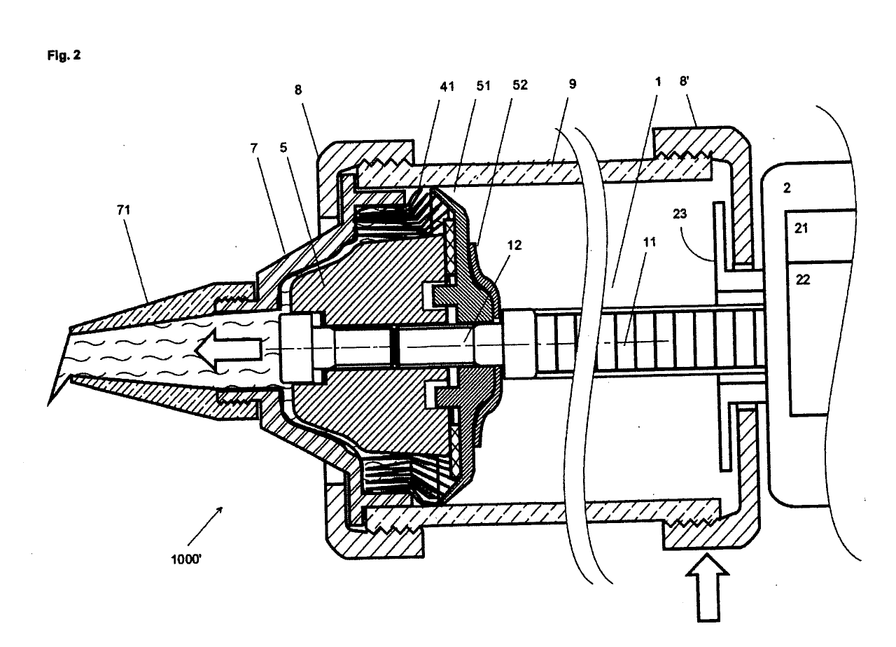

The device 1000′ known from [1] comprises a drive unit which is provided in a housing 3 and by means of which a main guide rod 1 connected on its front side to a main piston 5 is mounted in an axially displaceable manner and can be introduced into a main cylinder 9 in such a way that the piston 5 acts on the material 42 provided in a bag 4 in the main cylinder 9 and can displace this material through a closure element 7 and through an outlet element 71, or an outlet nozzle, screwed thereto and out of the main cylinder 9. The main cylinder 9 is connected on the drive side to the drive unit 2 by first mounting means or by a first mounting ring 8′ screwed to the main cylinder 9 and held by a connecting ring 23 (see FIG. 2), and is screwed on the front side to second mounting means 8 or to a second mounting ring 8 which holds the conically shaped closure element 7.

FIG. 1 shows a longitudinal section through the front part of the device 1000′ known from [1], and it can be seen here that the main piston 5 provided with a threaded bore is screwed to a threaded spindle 12 provided on the front side of the main guide rod 1 and is secured by a locking screw 53. Also shown are a supporting element 52 and a′ diaphragm 51 which each have a through opening serving to guide through the threaded spindle 12. The diaphragm 51 is used to take hold of the material 42 in the region of the inner wall of the main cylinder 9 and carry it along, in which process the film 41 of the bag 4, which becomes free after the material 41 has been dispensed, is continuously folded.

FIG. 2 shows the device of FIG. 1 after the complete emptying of the bag 4 and the almost complete folding of the bag film 41. FIG. 2 also schematically shows that the drive unit 2 comprises an electric motor 22 and an accumulator battery 21, which means that the device 1000′ can be operated in a decentralized fashion without permanent connection to a stationary energy source.

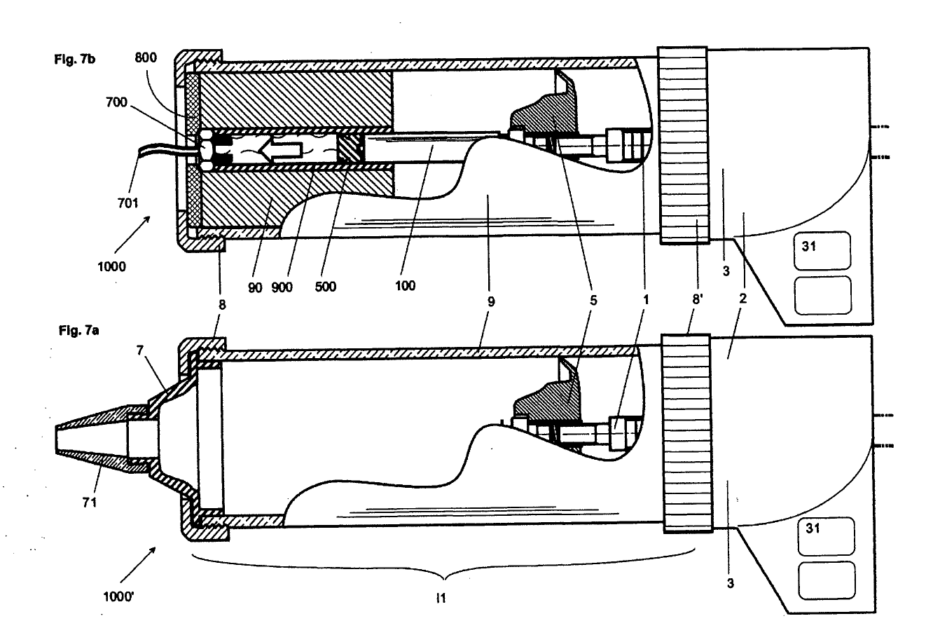

FIG. 7a shows the device 1000′ known from [1] in its entirety, with a housing 3 and control elements 31 provided on the latter by means of which the device 1000′ can be made to operate.

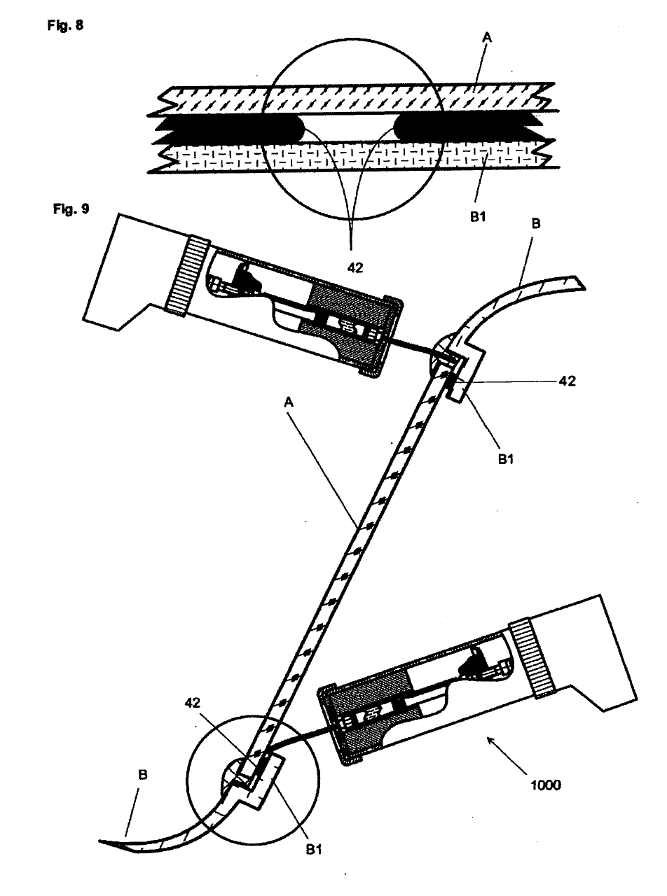

FIG. 3 shows a longitudinal section through the front part of the device 1000′ of FIG. 1 as expanded according to the invention. The device 1000 according to the invention is equipped with an auxiliary cylinder 900 in which the material 42 to be dispensed is contained and in which is arranged an auxiliary piston 500 which is actuated by means of the main guide rod 1 which is pushed into the auxiliary cylinder 900 against the auxiliary piston 500 by the drive unit 2. Actuating the main guide rod 1 causes the material 42 to be transferred through a closure element 700 screwed to the auxiliary cylinder 900 and through a hose-shaped outlet element 701 connected to this closure element and out of the auxiliary cylinder 900, and hence also out of the main cylinder. The flexible outlet element 701 preferably provided makes it possible for the material 42 to be fed to various points of an object A, B (see FIGS. 8 and 9) which are not accessible to the device 1000′ described in [1] and shown in FIGS. 1, 2 and 7b. By means of the flexible outlet element 701, the material 42 can be guided for example through gaps or channels to locations which are otherwise only accessible after disassembling the object A, B or parts thereof.

The inside diameter d2 of the hollow cylindrical auxiliary cylinder 900 is selected in relation to the inside diameter d1 of the hollow cylindrical main cylinder 9 or in relation to the force supplied by the drive unit 2 via the main guide rod 1 in such a way that the material 42 can be pressed out of the auxiliary cylinder 900 at the desired pressure and can be dispensed through an outlet element 701, for example a hose-shaped outlet element, having a small channel diameter. The ratio of the inside diameters d2/d1 lies for example in a range from 0.1 to 0.75, it preferably being ensured that the volume of the auxiliary cylinder 900 is sufficiently large in order to be able to completely accommodate the quantity of material 42 required for an application.

The auxiliary cylinder 900, which is preferably to be arranged coaxially and, if appropriate, parallel to the longitudinal axis of the main cylinder 9, can be mounted in the desired position using various measures. In the embodiment of FIG. 3, a hollow cylindrical reducing cylinder 90 is provided whose outside diameter corresponds to the inside diameter d1 of the main cylinder and whose inside diameter corresponds to the Outside diameter of the auxiliary cylinder 900. The reducing cylinder 90 is therefore held practically clearance-free inside the main cylinder 9 and the auxiliary cylinder 900 is held practically clearance-free inside the reducing cylinder 90. In this way, the auxiliary cylinder 900 can be mounted with few manipulations. Furthermore, the inside diameter of the reducing cylinder 90 can be selected in such a way that the auxiliary cylinder 900 can be produced from standard commercial pipes, for example electrical service pipes, which are available on the market at a favourable cost. After using an auxiliary cylinder 900, it can therefore be disposed of and replaced with a new pipe-piece.

As is further shown in FIG. 3, the auxiliary cylinder 900 can be closed off in a simple manner on the front side by means of a closure element 700 provided with a through bore, with a hexagonal profile and with a thread, which closure element can be screwed into an internal thread 901 cut into the front side of the auxiliary cylinder 900. An outlet element 701 can be formed in one piece on the closure piece 700. However, preference is given to using a closure element 700 into which a hose-shaped, flexible outlet element 701 can be inserted and, if appropriate, also released again by actuating a locking element. Such closure pieces 700 or fittings are available for example under http://www.legris.com/.

As material 42 is being dispensed, the main guide rod 1 acts with a high degree of force on the auxiliary cylinder 900. A retaining disc 800 provided with an opening 801 is therefore inserted into the second mounting ring 8 and absorbs this force and transmits it peripherally to the second mounting ring 8 so that the latter is not subject to point loading. The closure piece 700 here bears concentrically against the edge of the opening 801 of the retaining disc 800, with the outlet element 701 being routed outwardly through the opening 801.

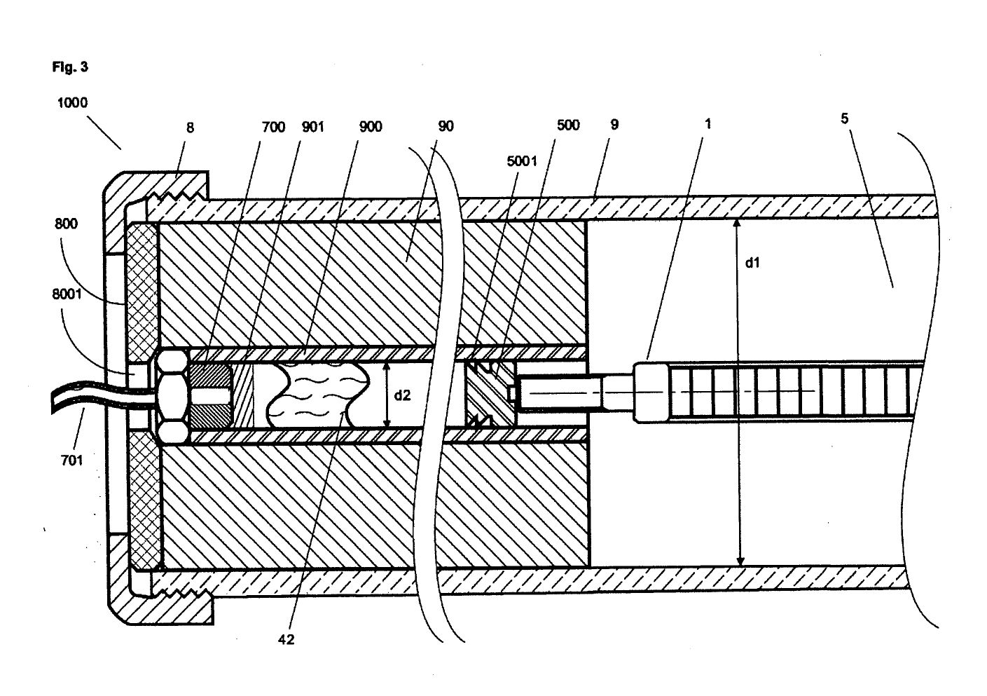

The embodiment of the invention shown in FIG. 3 is particularly suitable for devices 1000′ in which the main piston 5 can be removed quickly and with little effort. If, by contrast, the main piston 5 is not intended to be released, preference is given to using an auxiliary guide rod 100 as is shown in FIG. 4.

In FIG. 4, the main guide rod 1, or the main piston 5 provided thereon, is connected via the auxiliary guide rod 100 to the auxiliary piston 500 provided in the auxiliary cylinder 100. The auxiliary guide rod 100 therefore makes it possible for the force exerted by the auxiliary guide rod 100 to be transmitted to the auxiliary piston 500.

The auxiliary guide rod 100 can, for example, first be inserted into the auxiliary cylinder 900 and then introduced together with the latter into the main cylinder 9. Alternatively, the auxiliary guide rod 100 can be held in the main cylinder 9 by preferably two centring elements 101, 102, as is shown in FIG. 5. In this case, the auxiliary guide rod 100 is inserted into the centring elements 101, 102 and introduced together with the latter into the main cylinder 9.

In the embodiment of FIG. 4, there is additionally provided an auxiliary cylinder 900 whose outside diameter corresponds to the inside diameter d1 of the main cylinder 9. In this way, the reducing cylinder 90 and the retaining disc 800 can be avoided.

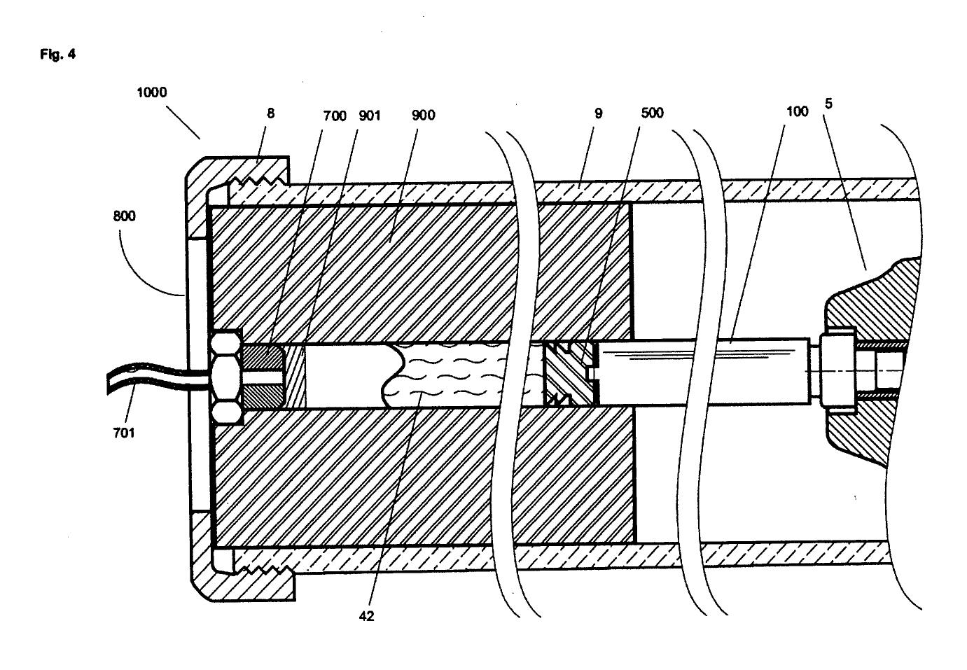

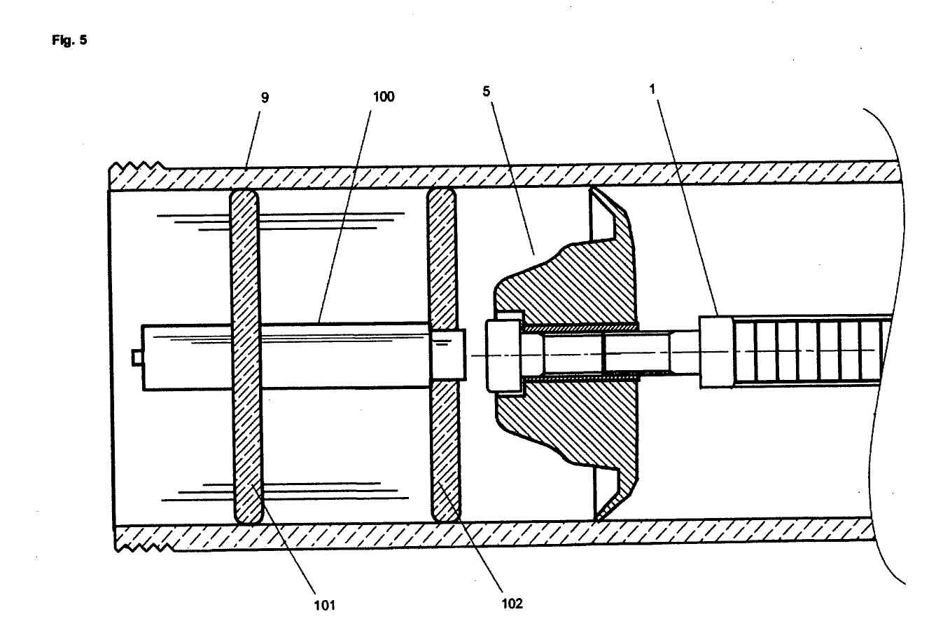

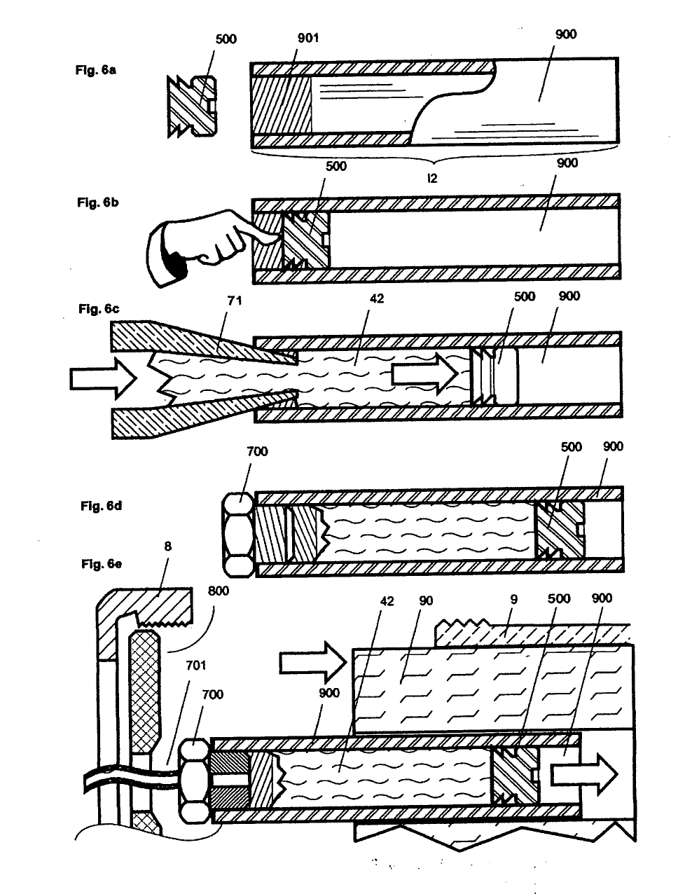

Auxiliary cylinders 900 are preferably prepared for use, as is shown in FIGS. 6a to 6e.

FIGS. 6a and 6b show that the auxiliary piston 500 is inserted, while being oriented rearwardly, into the front-side end of the auxiliary cylinder 900 provided with a thread 901. Then, for example with the device 1000′ in the configuration of FIG. 1, material 43 is introduced into the auxiliary cylinder 900, with the result that the auxiliary piston 500 is displaced towards the drive-side end of the auxiliary cylinder 900 (see FIG. 6c). After the material 43 has been poured in, the closure element 700 is screwed into the thread 901. The auxiliary cylinder 900 can now be inserted into the reducing cylinder 90 and be pushed together with the latter into the main cylinder 9, after which this main cylinder is closed off by the retaining disc 800 and the second mounting ring 8.

FIG. 7a shows the device 1000′ known from [1]. FIG. 7b shows a complete representation of the device 1000 according to the invention prepared for use. It can be seen from FIGS. 7a and 7b that the device 1000′ known from [1] can be configured according to the invention with few manipulations, with the result that this device can be converted quickly from the configuration for operation at a low pressure to a configuration according to the invention for operation at a pressure which is higher by a multiple. It is therefore possible according to the invention for the range of use for the device 1000′ known from [1] or for functionally identical devices to be expanded enormously with little effort. Only few device parts are required to achieve this. Furthermore, it is possible to operate with one and the same material, thereby avoiding incompatibilities or various application processes.

The parts of the device according to the invention are dimensioned in a manner envisaged by a person skilled in the art, it being the case that, after removing the main piston 5 and in the absence of an auxiliary guide rod 100, practically the entire space inside the main cylinder 9 can be used. However, the length 12 of the auxiliary cylinder 900, which is preferably made of plastic or metal, typically lies in the range from 0.2 to 0.8 times the length 11 of the main cylinder 9.

The main and auxiliary piston 5, 500 can have any desired design. Preferably, the auxiliary piston 500, which is made of plastic or metal, is provided with at least one peripheral collar 5001 which bears against the inner wall of the auxiliary cylinder 900.

The device 1000 according to the invention can advantageously be used in a variety of ways if the materials 42 to be processed are to be dispensed under greatly increased pressure, in particular using specially designed outlet elements, such as flexible hoses or curved pipes and lines.

The solution according to the invention can be used with particular advantage in the automotive sector to carry out repairs. Significant problems can thus be solved if, when mounting the front window or rear window, during production in the factory or during a local repair, unsealed areas occur which, for example, are not accessible to the devices described in [1] or to devices of the same generic type.

After a vehicle has been damaged, it is often the case that a smashed front window is replaced at the very spot where the incident occurred or in a nearby workshop. For this purpose, after the broken glass fragments have been removed and the body flange B1 (see FIGS. 8 and 9) has been cleaned, a new front window A is provided around its periphery with a peripheral and continuous adhesive bead 42 by means of the device 1000′ in the known configuration of FIG. 7a. The front window A is then placed on the body flange B1, after which the adhesive 42 situated in between connects the said parts A and B1 to one another. If an error occurred when dispensing the adhesive 42, for example because a new bag 4 of adhesive had to be installed or because the flow of adhesive 42 was interrupted by an air bubble or was not dispensed at a continuous flow rate, this can result in a gap in the applied bead of adhesive 42, as is shown in FIG. 8 (the defect or the gap is highlighted by a circle). After the new front window A has been mounted, an unsealed area thus appears, which can be located for example by means of ultrasonic measuring. For this purpose, an ultrasonic signal is emitted inside the vehicle and this signal can be detected at the unsealed area outside the vehicle by means of an ultrasonic sensor.

Since the unsealed area is not accessible by means of the device 1000′ in the known configuration of FIG. 7a, this device is expanded according to the invention with few manipulations such that it is possible to carry out the repair on the unsealed area by means of the device 1000 according to the invention in the configuration of FIG. 7b. The outlet element 701 in the form of a thin hose can therefore, as shown in FIG. 9, be guided, if appropriate through insulating materials, to the defective area at which material 42 is dispensed, for example until the ultrasonic signal can no longer be detected.

The invention has been described by way of example with reference to the device disclosed in [1]. However, numerous other devices are known from the prior art which can be expanded according to the invention. The individual device parts which are required for mounting the auxiliary cylinder 900 have to be adapted in a manner envisaged by a person skilled in the art.

Furthermore, devices known from the prior art can be expanded according to the invention and then used exclusively in this configuration. This is particularly the case when it is intended to operate permanently at very high pressure.

### LITERATURE REFERENCE

[1] WO 2005/120720 A1
[2] DE1 630 371 A1

### LIST OF REFERENCE SIGNS

1000 Device
1 Main guide rod
11 Ratchet rod
12 Threaded spindle
100 Auxiliary guide rod
101 First centring element for the auxiliary guide rod 100
102 Second centring element for the auxiliary guide rod 100
2 Drive unit
21 Accumulator battery
22 Electric motor
23 Connecting ring
3 Device housing
31 Control elements
4 Sausage-shaped bag
41 Casing of the bag
42 Material to be processed, such as sealing material or adhesive
5 Main piston
500 Auxiliary piston
51 Diaphragm
52 Supporting element
53 Locking screw
7 Main closure piece on the main cylinder 9
71 Main outlet element
700 Auxiliary closing piece on the auxiliary cylinder 900
701 Auxiliary outlet element or outlet hose
8, 8′ First and second mounting ring
800 Retaining disc
8001 Opening in the retaining disc 800
9 Main cylinder
90 Reducing cylinder
900 Auxiliary cylinder
901 Thread in the internal cylinder 900
A Windscreen
B Body part
B1 Flange elements for holding the windscreen

1. A device for dispensing viscous or pasty material, comprising a drive unit which is provided in a housing and by means of which a main guide rod which can be connected on its front side to a piston is mounted in an axially displaceable manner and can be introduced into a main cylinder, which is connected on the drive side to the drive unit by first mounting means and which on the front side holds at least one closure element by way of second mounting means, in such a way that the piston driven by the main guide rod can act on the material and displace this material through the closure element and out of the main cylinder, wherein there is provided an auxiliary cylinder which is filled with the material to be dispensed and which is held coaxially in the main cylinder, this auxiliary cylinder being provided on the front side with the closure element held by the second mounting means and having arranged therein, on the drive side, the piston which can be driven by means of the main guide rod.

2. The device according to claim 1, wherein the inside diameter of the hollow cylindrical auxiliary cylinder in relation to the inside diameter the hollow cylindrical main cylinder or in relation to the force supplied by the drive unit via the main guide rod is selected such that the material can be pressed out of the auxiliary cylinder at the desired pressure.

3. The device according to claim 1, wherein the second mounting means comprise a mounting ring which, on the one hand, can be used to hold a first closure element for the operation of the device without an auxiliary cylinder and which, for the operation of the device with an auxiliary cylinder, can be used to hold a retaining disc provided with an opening, and hence the second closure element connected to the auxiliary cylinder.

4. The device according to claim 1, wherein the main guide rod is provided on the front side with a main piston which, during the operation of the device without an auxiliary cylinder, displaces the material from the main cylinder and which, after the installation of the auxiliary cylinder, is connected to the piston provided in the auxiliary cylinder by means of an auxiliary guide rod.

5. The device according to claim 1, wherein a hollow cylindrical reducing cylinder is held practically clearance-free in the main cylinder and the auxiliary cylinder is held practically clearance-free inside this reducing cylinder, or in that the outside diameter of the auxiliary cylinder corresponds approximately to the inside diameter of the main cylinder such that the auxiliary cylinder is held practically clearance-free in the main cylinder.

6. The device according to claim 3, wherein the auxiliary guide rod is held in the main cylinder by means of the auxiliary cylinder and/or by means of at least one centring element.

7. The device according to claim 1, wherein the second closure element, which has a through bore, a polygonal profile and a thread, is screwed on the one hand into an internal thread provided on the front side of the auxiliary cylinder and connected on the other hand to a plastic hose.

8. The device according to claim 1, wherein the piston is provided with at least one peripheral collar which bears against the inner wall of the auxiliary cylinder.

9. The device according to claim 1, the length of the auxiliary cylinder lies in the range from 0.2 to 0.8 times the length of the main cylinder.

10. The method for closing gaps in adhesive or sealing materials in the automotive sector, comprising dispensing a viscous or pasty material using the device according to claim 1.

11. The device according to claim 1, wherein the viscous or pasty material is a sealing material or adhesive.

12. The device according to claim 2, wherein the ratio of the inside diameters is in a range from 0.1 to 0.75.

13. The device according to claim 4, wherein the auxiliary guide rod is oriented axially with respect to the main guide rod.

14. The device according to claim 8, wherein the piston is made of plastic or metal and is provided in the auxiliary cylinder.

15. The device according to claim 9, wherein the auxiliary cylinder is made of plastic or metal.

16. The method according to claim 10, wherein the gaps in adhesive or sealing materials are gaps that remain between a window and a bearing flange of a vehicle body after mounting a window.
